(19) United States
(12) Patent Application Publication
(10) Pub. No.: US 2009/0189567 A1
(43) Pub. Date: Jul. 30, 2009

(54) Zinc Anode Battery Using Alkali Ion Conducting Separator

(76) Inventors: Ashok V. Joshi, Salt Lake City, UT (US); John Howard Gordon, Salt Lake City, UT (US); Sai Bhavaraju, West Jordan, UT (US)

Correspondence Address: CERAMATEC, INC., 2425 SOUTH 900 WEST, SALT LAKE CITY, UT, 84119, US

(21) Appl. No.: 12/022,381

(22) Filed: Jan. 30, 2008

(51) Int. Cl. H01M 10/36; H01M 10/44

(52) U.S. Cl. 320/127; 429/206; 320/137

(57) ABSTRACT

A zinc anode storage battery comprising a first electrode containing zinc or a zinc alloy, a second electrode containing an oxidizing material capable of electrochemical reduction by zinc, an alkaline electrolyte, and a substantially non-porous, alkali-ion conducting separator provided between the first electrode and the second electrode. The alkali conducting separator may be a solid alkali metal ion super ion conducting material, wherein the alkali metal is Na, K, or Li.

### BACKGROUND OF THE INVENTION

This invention relates to a zinc anode battery that includes a non-porous, alkali ion conducting separator. The invention further relates to rechargeable zinc anode batteries that inhibit zinc dendrite formation.

Due to its relatively low price and good electrochemical properties, zinc has long been a desirable ingredient for the negative electrode or anode in rechargeable batteries and electrochemical cells, particularly in cells employing alkaline electrolytes. However, one of the major problems relative to zinc-containing anodes has been the relatively short life of such cells due to the formation of harmfully excessive zinc dendrites during the recharging cycle, which tend to cause shorting.

FIG. 1 shows a schematic representation of zinc anode battery 10 having a positive electrode 12, a negative electrode 14, and a separator 16. The separator provides electrical isolation between the electrodes while still allowing efficient ionic diffusion between them. The separators often used in zinc anode cells typically include woven or nonwoven fabric comprising a polyamide and polyolefin, or a porous film of a fluoro-polymer film. A known effective separator is a nylon fiber blend. Other polymeric fibers are used in separators.

The electrolyte used in the zinc anode battery is alkaline. It commonly includes an aqueous solution of potassium hydroxide. In some known zinc anode batteries, the electrolyte is ammonium chloride, NH₄Cl. The electrolyte may contain other minor constituents to enhance cell performance.

Rechargeable alkaline-zinc anode batteries are useful for a variety of applications, to provide electrical energy upon discharge of the battery and to recharge the battery after discharge. The charge and discharge reactions for a typical zinc anode battery using a silver oxide (AgO) cathode are shown below. It will be appreciated that other cathodes are known and used with zinc anode batteries, including but not limited to, oxygen (air), manganese dioxide (MnO₂), nickel hydroxide (NiOOH), and others. If the alkali metal hydroxide is LiOH and a manganese oxide cathode is used, Li is known to insert into the MnO₂ structure as described by Minakshi et al. (See Minakshi, Manickam; Singh, Pritam; Issa, Touma B.; Thurgate, Stephen; De Marco, Roland, “Lithium insertion into manganese dioxide electrode in MnO₂/Zn aqueous battery: Part I. A preliminary study”, Journal of Power Sources, v 130, n 1-2, May 3, 2004, p 254-259.)

Positive electrode:

Ag+2OH⁻→AgO+H₂O+2e⁻ (charge)

AgO+H₂O+2e⁻→Ag+2OH⁻ (discharge)

Negative electrode:

Zn(OH)₂+2e⁻→Zn+2OH⁻ (charge)

Zn+2OH⁻→Zn(OH)₂+2e⁻ (discharge)

Overall reaction:

Ag+Zn(OH)₂→AgO+Zn (charge)

AgO+Zn→Ag+Zn(OH)₂ (discharge)

From the overall reactions shown above, hydroxide ions move from the negative electrode to the positive electrode during charge and reverse direction during discharge.

Presently, a major problem in a rechargeable alkaline-zinc cell is the extended formation of deleterious zinc dendrite overgrowth during the recharging cycle which short out and thereby destroy the cell. The formation of dendritic zinc occurs when zinc metal becomes deposited out onto the anode during the charging operation as a result of the reduction to metallic metal of the zinc ions present in the form of highly soluble alkali zincate in the alkaline electrolyte. A high current density occurs at the edges of the electrode and along the boundaries thereof. This concentration causes metallic zinc crystals to initiate, forming as outwardly-pointed dendrites and accumulating at these locations. These zinc metal dendrites, forming as an overgrowth on the normal initial zinc deposit on the negative electrode (anode) during charge, tend to rapidly span the narrow gap between the positive and negative electrodes and short circuit the cell by forming a current-conducting bridge, not only at the edges of the electrode, but also where their pointed ends penetrate through the porous membranes and separators located between the positive and negative electrodes, thus causing short circuiting of the cells after only a very few discharge and recharge cycles. Another problem encountered with porous separators is the migration of soluble and insoluble species from anode to cathode and vice-versa which result in loss of capacity either on the shelf or over the course of cell cycling.

It would be an improvement in the art to provide a rechargeable zinc anode battery with reduced or eliminated dendrite formation and which also prevented the migration of soluble and insoluble species from one electrode to the other.

### BRIEF SUMMARY OF THE INVENTION

In accordance with the present invention, there is provided herein a zinc anode battery that contains an alkali ion conducting separator configured to selectively transport alkali ions. The zinc anode battery contains a first electrode comprising zinc, which under certain operational conditions may be an anode or negative electrode, and a second electrode, which under certain operating conditions may be a cathode or positive electrode. Throughout the specification, the term “first electrode” may be used interchangeably with the term “zinc electrode” and the term “second electrode” may be used interchangeably with the term “opposite electrode.” The term “zinc” is meant to include all zinc containing materials including without limitation zinc alloys and compounds. The alkali ion conducting separator is disposed between the first and second electrodes. The battery includes an alkaline electrolyte, such as an alkali metal hydroxide.

In one embodiment of the invention, the separator is a substantially non-porous ceramic separator material. Without being bound by theory, it is presently believed that dendrite formation and/or penetration of dendrites from the anode to the cathode may be substantially reduced or eliminated by using a substantially non-porous, alkali ion conducting separator.

The separator in one embodiment is an alkali ion conducting solid electrolyte configured to selectively transport alkali ions and which may be electronically insulating. It may be a specific alkali ion conductor. For example, the alkali ion conducting solid electrolyte may be a solid MeSICON (Metal Super Ion CONducting) material, where Me is Na, K, or Li. The alkali ion conducting solid electrolyte may comprise a material having the general formula [M^{I}][M^{II}][A₂^{IV}][B₃^{V}]O₁₂, where M^{I}, M^{II}, and A^{IV} are cations with respective oxidation states of +1, +2 and +4, and where B^{V} is a cation with oxidation state of +4 or +5 and where M-site cations could be Li, Na, K, Mg, Ca, Se, Ba, Ag, A-site cations are Zr, Ti, Sn, Nb, Hf, Al, Y, Sc, Yb, Fe, or La and where B-site cations are P or Si. Examples of materials generally following the formula above with some slight modification is: Me₁₊ₓZr₂SiₓP₃₋ₓO₁₂ where 0≦x≦3, where Me is Na, K, or Li. Another example is Na₁₊ₓZr₂P₃₋ₓSiₓO₁₂. Another example is Li₁₊ₓAlₓTi₂₋ₓ(PO₄)₃ or more specifically Li_{1.3}Al_{0.3}Ti_{1.7}(PO₄)₃ Other alkali ion conducting solid electrolytes may comprise a material having the formula Me₅RESi₄O₁₂ where Me is Na, K, or Li, where RE is Y, Nd, Dy, or Sm, or any mixture thereof. The alkali ion conducting solid electrolyte may comprise a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where δ is the measure of deviation from stoichiometry. The alkali ion conducting separator may be beta-alumina.

The alkali ion conducting separator may be configured in the form of a monolithic flat plate, a monolithic tube, a monolithic honeycomb, or supported structures of the foregoing. The alkali ion conducting separator may be a flexible sheet of the polymer configured in various forms applicable to the intended application. The alkali ion conducting separator may be a flexible sheet composed of a mixture of polymer and ceramic and configured in a variety of forms. The alkali ion conducting separator may be configured as a layered alkali ion conducting ceramic-polymer composite membrane comprising alkali ion selective polymers layered on alkali ion conducting ceramic solid electrolyte materials.

The charge and discharge reactions for a typical zinc anode battery are shown below:

Opposite electrode:

Mₒₓ+2MeOH→MₒₓO+H₂O+2Me⁺+2e⁻ (charge)

MₒₓO+H₂O+2Me⁺+2e⁻→Mₒₓ+2MeOH (discharge)

Zinc electrode:

Zn(OH)₂+2Me⁺+2e⁻→Zn+2MeOH (charge)

Zn+2MeOH→Zn(OH)₂+2Me⁺+2e⁻ (discharge)

Overall reaction:

Mₒₓ+Zn(OH)₂→MₒₓO+Zn (charge)

MₒₓO+Zn→Mₒₓ+Zn(OH)₂ (discharge)

Where Me is an alkali metal, including but not limited to, Li, Na, and K, and Mₒₓ is a oxidizing material. It will be appreciated that a variety of oxidizing materials may be used with zinc anode batteries, including but not limited to, silver (AgO or Ag₂O), manganese (MnO₂), nickel (NiOOH), copper (Cu₂O), and others. The oxidizing material may also include cathode materials that are presently discouraged because of environmental or health issues, such as mercury (HgO) or cadmium (CdO). The oxidizing material may include oxygen (air). Persons having ordinary skill in the art will appreciate that Mₒₓ is not limited to metals that oxidize to a +2 valence, but can include any material that will be electrochemically reduced by zinc in the presence of an alkaline electrolyte. Thus, in one embodiment, zinc operates as a reducing agent.

The charge and discharge reactions for a typical zinc anode battery where the second or opposite electrode material is able to insert alkali ions are shown below:

Opposite electrode:

Mᵢ-Me→Mᵢ+Me⁺+e⁻ (charge)

Mᵢ+Me⁺+e⁻→Mᵢ-Me (discharge)

Zinc electrode:

½Zn(OH)₂+Me⁺+e⁻→½Zn+MeOH (charge)

½Zn+MeOH→½Zn(OH)₂+Me⁺+e⁻ (discharge)

Overall reaction:

Mᵢ-Me+½Zn(OH)₂ Mᵢ+½Zn+MeOH (charge)

Mᵢ+½Zn+MeOH→Mᵢ-Me+½Zn(OH)₂ (discharge)

Where Me is an alkali metal, including but not limited to, Li, Na, and K, and Mᵢ is a oxidizing material reducible by zinc that inserts Me⁺ ions on reduction and releases them on oxidation.

The invention includes a method of charging a zinc anode battery. In the method, an electrical potential is applied to the second or opposite electrode and the first or zinc electrode to cause the charging reactions to occur, identified above. During the charging process, alkali ions are conducted across the alkali ion conducting separator toward the Zn electrode from the opposite electrode.

The invention includes a method of discharging a zinc anode battery. In the method, an electric potential is generated between the second or opposite electrode and the first or zinc electrode due in part to the discharge reactions, identified above. During the discharging process, alkali ions are conducted across the alkali ion conducting separator from the zinc (negative) electrode to the opposite (positive) electrode.

The use of an alkali-ion conductive, substantially non-porous separator disposed between the electrodes inhibits or prevents dendrite formation and/or the penetration of dendrites from the zinc electrode to the opposite electrode in the battery. The non-porous separator also advantageously prevents transport of unwanted species from one electrode to the other and substantially eliminates capacity loss and self discharge. Also any additives added to improve the performance of the electrodes will be confined to the respective compartments by the non-porous ceramic separator.

In the present battery using the alkali metal ion conducting separator, the current carrying species in the electrolyte are exclusively alkali metal ions. The separator conducts alkali ions, but is substantially impermeable to hydroxide ions. Also the concentrations of the electrolyte change at both electrodes during battery operation because the non porous separator prevents mixing of electrolyte from both the compartments.

In one embodiment of the invention, the separator is a substantially non-porous ceramic separator material. The substantially non-porous ceramic separator material may include pockets of porosity, but it should not have “through-porosity.” The substantially non-porous separator may be hermetic or gas-impermeable. However, the substantially non-porous separator used within the scope of the present invention may possess a trace amount of through porosity and/or gas permeability. The term substantially non-porous is intended to differentiate the prior art separators that are substantially porous.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment, but may refer to every embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic representation of a conventional zinc anode alkaline battery.

FIG. 2 is a schematic representation of a zinc anode alkaline battery within the scope of the invention.

FIG. 3 is a graph of the discharge capacity versus charge/discharge cycle number for a zinc anode alkaline battery using a sodium ion super conducting separator.

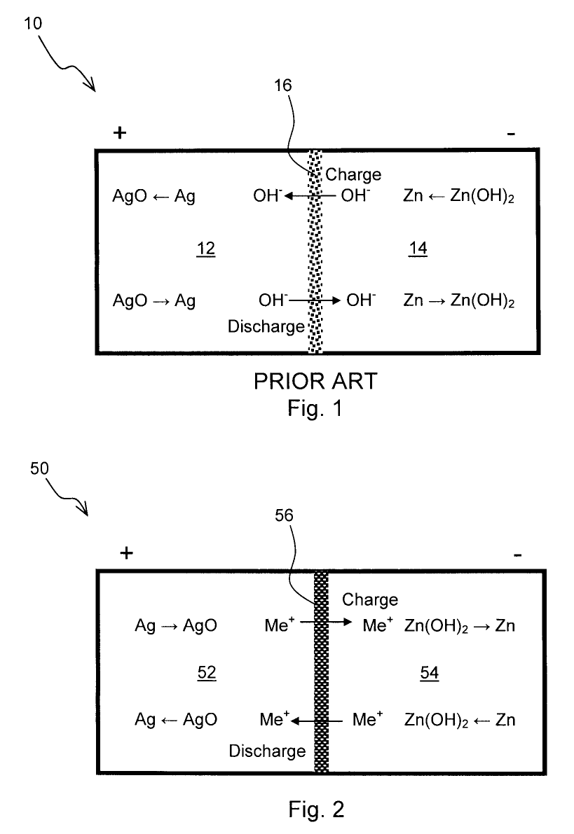

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of cells, membranes, processes, methods, etc., to provide a thorough understanding of embodiments of the invention. One skilled in the relevant art will recognize, however, that the invention may be practiced without one or more of the specific details or method steps, or with other methods, components, materials, and so forth. In other instances, well-known structures, materials, or operations are not shown or described in detail to avoid obscuring aspects of the invention.

The embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the zinc anode alkaline battery using an alkali metal conducting separator within the scope of the present invention as represented in the Figures, is not intended to limit the scope of the invention, as claimed, but is merely representative of the embodiments of the invention.

Referring to FIG. 2, there is provided a schematic representation of a zinc anode alkaline battery 50 within the scope of the invention. In one embodiment, battery 50 includes an electrode 52 that is positive on discharge, an electrode 54 that is negative on discharge, and an alkali ion conducting separator 56. While not shown in FIG. 2, the battery 50 includes an electrolyte, such as an alkali metal hydroxide. The electrolyte may contain other minor constituents to enhance cell performance and cyclability.

The electrode 52, or cathode, may comprise a substance that will be reduced (electrochemically) by zinc but which is non reactive with an alkaline electrolyte. In the battery 50, the oxidizing material may be selected from a group of substances that will reduce when in electrical communication with zinc through a circuit and in ionic communication through separator 56. It will be appreciated that a variety of oxidizing materials may be used with zinc anode batteries, including but not limited to, silver oxide (AgO or Ag₂O), manganese oxide (MnO₂), nickel oxide (NiOOH), copper oxide (Cu₂O), and others. The second or opposite electrode may also include materials that are presently discouraged because of environmental or health issues, such as mercury (HgO) or cadmium (CdO). The oxidizing material may include oxygen (air). Persons having ordinary skill in the art will appreciate that Mₒₓ is not limited to metals that oxidize to a +2 valence, but any material that will be electrochemically reduced by zinc in the presence of an alkaline electrolyte.

The electrode 54 may comprise zinc, including without limitation, a suitably reactive zinc alloy.

The balance between the zinc and opposite electrodes may be adjusted so that the cell is limited by the opposite electrode. This means that the zinc electrode possesses a greater capacity than the opposite electrode. The opposite electrode will reach full capacity first as the cell is charged. On overcharge, the opposite electrode will generate oxygen gas that may vent to the zinc electrode where it is recombined to form water or reduce to form hydroxide ions. Similarly on overdischarge, the opposite electrode may generate hydrogen gas that may vent to the zinc electrode where it is oxidized to form water.

Opposite electrode:

4OH⁻→2H₂O+O₂+4e⁻ (Overcharge)

Zinc electrode:

2H₂O+O₂+4e⁻→4OH⁻

Opposite electrode:

2H₂O+2e⁻→H₂+2OH⁻ (Overdischarge)

Zinc electrode:

H₂+2OH⁻→2H₂O+2e⁻

The means of venting the gases produced at the opposite electrode to the zinc electrode may be a one way check valve. For example, wherein overcharging generates oxygen at the opposite electrode, the oxygen can be directed through a one way check valve to the zinc electrode which can reduce the oxygen. Similarly, when overdischarging generates hydrogen at the opposite electrode, the hydrogen can be directed through a one way check valve to the zinc (zinc hydroxide) electrode where it can be oxidized to water. Alternatively, by limiting the amount of electrolyte provided for either opposite or zinc electrode reactions, the overcharge or overdischarge can be avoided. Such a feature is not possible with prior art battery constructions. The electrolytes on each side of the separator may have different alkalinity. Similarly, the electrolyte concentration may be selected to limit the capacity of the battery and to prevent overcharging and overdischarging.

The alkali ion conducting separator 56 provides electrical isolation between the electrodes while still allowing cationic transport between them. In one embodiment, the separator 56 is a substantially non-porous alkali ion conducting separator. This may be accomplished using a dense alkali ion conductor. In one embodiment, the solid alkali electrolyte has high ionic conductivity with minimal or negligible electronic conductivity. The alkali ion conducting separator may have high selectivity to preferred ionic species.

The alkali ion conducting separator 56 may selectively transport a particular, desired alkali metal cation species between the zinc and opposite electrodes even in the presence of other cation species. The alkali ion conducting separator 56 may also be substantially impermeable to water, hydrogen and/or other undesired metal cations.

This impermeability of the separator can be advantageously used by having two dissimilar alkaline electrolytes on either side of the separator without coming into contact with each other. One of the well known problems associated with Zn electrode in alkaline electrolyte is the formation of spongy or mossy Zn deposits during charge even at low current densities. These deposits result in Zn electrode shape change and dendritic growth. The main reason for such deposits is due to high solubility of discharge products of the Zn electrode. Presence of Ca(OH)₂ in the electrode or electrolyte decreases the solubility of Zn electrode discharge products. Certain additives such as HgO and Ga₂O₃ promote fine Zn deposits low polarizability on charging. Additives such as PbO and In(OH)₃ increase the polarizability and inhibit shape changes. Other organic additives such as alkaline metal salts of 1,3,5-phenyltrisulfonic acid are known to significantly enhance Zn electrode cycle life. In a prior art cell with porous separator these additives may affect the performance of the opposite electrode. Many of these additives can be effectively employed in the present cell with non-porous separator as these additives are contained in the Zn electrode compartment.

Similarly a unique electrolyte may be used in the zinc electrode compartment. For example, Zn electrode can be effectively cycled by the use of low alkalinity electrolytes containing highly soluble salts such as phosphate, borate or fluoride. Alternatively an inhibitor to prevent the corrosion of the zinc electrode can be located within the zinc electrode compartment. The corrosion inhibitor can reduce corrosion of the electrode either in the charge or discharge state. An example of corrosion inhibitor of the zinc electrode during charge-discharge cycling is indium, bismuth, lead or combinations thereof alloyed with the zinc.

Also an oxygen scavenger can be placed in the opposite electrode compartment to withhold the oxygen produced on overcharge. The oxygen scavenger can either be present in the electrolyte or can be in a gas permeable, but electrolyte impermeable, pack located in the opposite electrode compartment. The oxygen scavenger may be reversible or irreversible. Examples of such oxygen scavengers include ferrous oxide, unsaturated hydrocarbons, sulfites, cobalt (II) amine complexes, benzoacrylates, cobalt catalyzed nylon MXD6 imbedded in the plastic structure (Oxbar™). Alternatively a hydrogen scavenger may be used instead of an oxygen scavenger to withhold the hydrogen produced on overdischarge. Examples of hydrogen scavengers include palladium metal, organic nitro compounds, furans, norbornadiene and other unsaturated hydrocarbons.

In some embodiments, the zinc anode battery may be operated at temperatures from about −40° C. to about 120° C.

A variety of alkali ion conducting separator materials are known in the art and would be suitable for constructing the alkali ion conducting separator 56 of the present invention, as would be understood by one of ordinary skill in the art. In accordance with the present invention, in some specific embodiments alkali ion conducting separator 56 compositions comprising an alkali metal ion super ionic conductor (MeSICON, where Me is Na, K, or Li) materials are utilized for their characteristics of high ion-conductivity for alkali ions at low temperatures, selectivity for alkali ions, current efficiency and chemical stability in water, ionic solvents, and corrosive alkali media under static and electrochemical conditions. Such alkali ion conducting separators 56 may have desirable characteristics which make them suitable for use in zinc anode battery applications. One such characteristic is that, being dense, the separator 56 is at least substantially impervious to soluble species which may greatly limit or prevent self-discharge.

As noted above, in some specific embodiments, the alkali cation conducted by the alkali ion conducting separator is the sodium ion (Na⁺). In some specific embodiments, sodium-ion conducting ceramic membranes comprise materials of general formula Na₁₊ₓZr₂SiₓP₃₋ₓO₁₂ where 0≦x≦3, as disclosed in U.S. Pat. No. 5,290,405. The alkali ion conducting separator may include materials of general formula Na₅RESi₄O₁₂ and non-stoichiometric sodium-deficient materials of general formula (Na₅RESi₄O₁₂)_{1-δ}(RE₂O₃.2SiO₂)₆, where RE is Nd, Dy, or Sm, or any mixture thereof and where 6 is the measure of deviation from stoichiometry, as disclosed in U.S. Pat. No. 5,580,430. Analogs of these sodium-conducting solid electrolyte materials transport other alkali ions such as Li and K.

In some specific embodiments, the alkali ion conducting separator material may include at least one of the following: materials of general formula Me₁₊ₓMe^{I}₂SiₓP₃₋ₓO₂ where 0≦x≦3, where Me is selected from the group consisting of Li, Na, K, or mixture thereof, and where Me^{I} is selected from the group consisting of Zr, Ge, Ti, Sn, or Hf, or mixtures thereof, materials of general formula Na_{1+z}L_{z}Zr_{2-z}P₃O₁₂ where 0≦z≦2.0, and where L is selected from the group consisting of Cr, Yb, Er, Dy, Sc, Fe, In, or Y, or mixtures or combinations thereof; materials of general formula Me^{II}₅RESi₄O₁₂, where Me^{II} may be Li, Na, or any mixture or combination thereof, and where RE is Y or any rare earth element. In some specific embodiments, the alkali conducting solid electrolyte materials may include at least one of the following: non-stoichiometric materials, zirconium-deficient (or sodium rich) materials of general formula Na₁₊ₓZr_{2-x/3}SiₓP₃₋ₓO_{12-2x/3} where 1.55≦x≦3. In some specific embodiments, the alkali ion conducting solid electrolyte materials may include at least one of the following: non-stoichiometric materials, sodium-deficient materials of general formula Na₁₊ₓ(A_{y}Zr_{2-y})(Si_{z}P_{3-z})O_{12-δ} where A is selected from the group consisting of Yb, Er, Dy, Sc, In, or Y, or mixtures or combinations thereof, 1.8≦x≦2.6, 0≦y≦0.2, x<z, and 6 is selected to maintain charge neutrality. In some specific embodiments, the solid electrolyte materials may include sodium-deficient materials of formula Na_{3.1}Zr₂Si_{2.3}P_{0.7}O_{12-δ}.

Other exemplary sodium super ion conducting materials (NaSICON-type materials) are described by H. Y—P. Hong in “Crystal structures and crystal chemistry in the system Na₁₊ₓZr₂SiₓP₃₋ₓO₁₂,” Materials Research Bulletin, Vol. 11, pp. 173-182, 1976; J. B. Goodenough et al., in “Fast Na⁺-ion transport skeleton structures,” Materials Research Bulletin, Vol. 11, pp. 203-220, 1976; J. J. Bentzen et al., in “The preparation and characterization of dense, highly conductive Na₅GdSi₄O₁₂ NaSICON (NGS),” Materials Research Bulletin, Vol. 15, pp. 1737-1745, 1980; C. Delmas el al., in “Crystal chemistry of the Na₁₊ₓZr₂₋ₓLₓ(PO₄)₃ (L=Cr, In, Yb) solid solutions,” Materials Research Bulletin, Vol. 16, pp. 285-290, 1981; V. von Alpen et al., in “Compositional dependence of the electrochemical and structural parameters in the NASICON system (Na₁₊ₓSiₓZr₂P₃₋ₓO₁₂),” Solid State Ionics, Vol. 3/4, pp. 215-218, 1981; S. Fujitsu et al., in “Conduction paths in sintered ionic conductive material Na₁₊ₓYₓZr₂₋ₓ(PO₄)₃,” Materials Research Bulletin, Vol. 16, pp. 1299-1309, 1981; Y. Saito et al., in “Ionic conductivity of NASICON-type conductors Na_{1.5}M_{0.5}Zr_{1.5}(PO₄)₃ (M: Al³⁺, Ga³⁺, Cr³⁺, Sc³⁺, Fe³⁺, In³⁺, Yb³⁺, Y³⁺),” Solid State Ionics, Vol. 58, pp. 327-331, 1992; J. Alamo in “Chemistry and properties of solids with the [NZP] skeleton,” Solid State Ionics, Vol. 63-65, pp. 547-561, 1993; K. Shimazu in “Electrical conductivity and Ti⁴⁺ ion substitution range in NASICON system,” Solid State Ionics, Vol. 79, pp. 106-110, 1995; Y. Miyajima in “Ionic conductivity of NASICON-type Na₁₊ₓMₓZr₂₋ₓP₃O₁₂ (M: Yb, Er, Dy),” Solid State Ionics, Vol. 84, pp. 61-64, 1996. These references are incorporated in their entirety herein by this reference.

While the alkali ion conducting separator materials disclosed herein encompass or include many formulations of alkali ion super ion conducting (MeSICON, where Me is an alkali metal) materials, this disclosure includes specific examples of ceramic membranes comprising NaSICON materials for the sake of simplicity. The focused discussion of NaSICON materials as one example of materials is not, however, intended to limit the scope of the invention. For example, the materials disclosed herein as being highly conductive and having high selectivity include those alkali super ion conducting materials that are capable of transporting or conducting any alkali cation, such as sodium (Na), lithium (Li), potassium (K), ions for separating electrodes of a zinc anode battery.

Another class of materials that can be used as non-porous separators are alkali ion conducting glasses. Similar to MeSICON materials these materials can be classified as super ionic conductors with high alkali ion conductivity. Examples are sodium fluoro zirconate glass, sodium borate glass, sodium silicate glass among others.

The alkali ion conducting solid electrolyte materials may be used or produced for use in the processes and apparatus of the present invention in any suitable form, as would be understood by one of ordinary skill in the art. In some specific embodiments, the form of the alkali ion conducting solid electrolyte may include at least one of the following: monolithic flat plate geometries, supported structures in flat plate geometries, monolithic tubular geometries, supported structures in tubular geometries, monolithic honeycomb geometries, or supported structures in honeycomb geometries.

In another embodiment, the alkali ion conducting separator 56 may be configured as a supported membrane structure. Supported structures or membranes may comprise dense layers of ion-conducting ceramic solid electrolyte supported on porous supports. A variety of forms for the supported membranes are known in the art and would be suitable for providing the supported membranes for alkali ion conducting separator with supported structures, including: ceramic layers sintered to below full density with resultant continuous open porosity, slotted-form layers, perforated-form layers, expanded-form layers including a mesh, or combinations thereof. In some embodiments, the porosity of the porous supports is substantially continuous open-porosity so that the liquid solutions on either side of the alkali ion conducting solid electrolyte may be in intimate contact with a large area of the dense-layers of alkali ion conducting ceramic solid electrolytes, and in some, the continuous open-porosity ranges from about 30 volume % to about 90 volume %. In some embodiments of the present invention, the porous supports for the supported structures may be present on one side of the dense layer of alkali ion conducting ceramic solid electrolyte. In some embodiments of the present invention, the porous supports for the supported structures may be present on both sides of the dense layer of alkali ion conducting ceramic solid electrolyte.

A variety of materials for the porous supports or supported membranes are known in the art and would be suitable for providing the porous supports for alkali ion conducting solid electrolyte materials, including: electrode materials, NaSICON-type materials, β^{I}-alumina, β^{II}-alumina, other ion-conducting ceramic solid electrolyte materials, and non-conductive materials such as plastics or ceramic materials, metals, and metal alloys. The thickness of the dense layer of alkali ion conducting solid electrolyte material in monolithic structures is generally from about 0.01 mm to about 5 mm, and in some instances from about 0.1 mm to about 1 mm. The thickness of the dense layer of alkali ion conducting ceramic solid electrolyte material in supported-structures is generally from about 25 μm to about 2 mm, and often from about 0.5 mm to about 1.5 mm. Layers as thin as about 25 μm to about 0.5 mm are readily producible, as would be understood by one of ordinary skill in the art.

In some specific embodiments, the porous substrate has similar thermal expansion and good bonding with the alkali ion conducting solid electrolyte as well as good mechanical strength. One of ordinary skill in the art would understand that the number and configuration of the layers used to construct the alkali ion conducting separator 56 as supported-structures could be widely varied within the scope of the invention.

In some embodiments, the alkali ion conducting solid electrolytes may be composites of alkali ion conducting ceramic solid electrolyte materials with non-conductive materials, where the non-conductive materials are poor ionic and electronic electrical conductors under the conditions of use. A variety of insulative non-conductive materials are also known in the art, as would be understood by one of ordinary skill in the art. In some specific embodiments, the non-conductive materials may include at least one of the following: ceramic materials, polymers, and/or plastics that are substantially stable in the media to which they are exposed.

Layered alkali ion conducting ceramic-polymer composite membranes are also particularly suitable for use as alkali ion conducting solid electrolytes in the present invention. Layered alkali ion conducting ceramic-polymer composite membranes generally comprise ion-selective polymers layered on alkali ion conducting ceramic solid electrolyte materials. In some specific embodiments, the alkali ion conducting ceramic solid electrolyte materials of the layered alkali ion conducting ceramic-polymer composite membranes may include at least one of the following: alkali ion super ion conducting type materials or beta-alumina. Ion-selective polymer materials have the disadvantage of having poor selectivity to sodium ions, yet they demonstrate the advantage of high chemical stability and are flexible. Therefore, layered alkali ion conducting ceramic-polymer composite membranes of alkali ion conducting ceramic materials with chemically stable ionic-selective polymer layers may be suitable for use in the present invention. In some specific embodiments, the types of ion-selective polymer materials which may be used in the layered alkali ion conducting ceramic-polymer composite structure may include at least one of the following: polyelectrolyte perfluorinated sulfonic polymers, polyelectrolyte carboxylic acid polymers, Nafion® materials (from E.I. du Pont de Nemours, Wilmington, Del.) and polyvinyl chloride (PVC), matrix-based polymers, co-polymers or block-copolymers.

In some specific embodiments, the polymers for the layered alkali ion conducting ceramic-polymer composite membranes may include at least one of the following features and use characteristics, as would be understood by one of ordinary skill in the art: high chemical stability; high ionic conductivity; good adhesion to alkali ion conducting ceramic materials; and/or insensitivity to impurity contamination.

In some specific embodiments, the alkali ion conducting solid electrolyte may comprise two or more co-joined layers of different alkali ion conducting solid electrolyte materials. Such co-joined alkali ion conducting solid electrolyte layers could include alkali ion super ion conducting materials joined to other alkali ion conducting ceramic materials, such as, but not limited to, beta-alumina. Such co-joined layers could be joined to each other using a method such as, but not limited to, thermal spraying, plasma spraying, co-firing, joining following sintering, etc. Other suitable joining methods are known by one of ordinary skill in the art and are included herein.

The alkali ion conducting ceramic solid electrolyte materials disclosed herein are particularly suitable for use as a separator in zinc anode alkaline battery applications because they have high ion-conductivity for alkali metal cations at low temperatures, high selectivity for alkali metal cations, good current efficiency and stability in water and corrosive media under anticipated operating conditions. Comparatively, beta alumina is a ceramic material with high ion conductivity at temperatures above 300° C., but has low conductivity at temperatures below 100° C., making it less practical for applications below 100° C.

Sodium ion conductivity in NaSICON structures has an Arrhenius dependency on temperature, generally increases as a function of temperature. The sodium ion conductivity of ceramic membranes comprising NaSICON materials ranges from about 1×10⁻⁴ S/cm to about 1×10⁻¹ S/cm from room temperature to 85° C.

Alkali ion conducting ceramic membranes comprising NaSICON materials, especially of the type described herein, have low or negligible electronic conductivity, and as such aid in virtually eliminating the occurrence of any self-discharge galvanic reactions. Certain NaSICON analogs according to the present invention have very mobile cations, including, but not limited to lithium, sodium, and potassium ions, that provide high ionic conductivity, low electronic conductivity and comparatively high corrosion resistance.

The following examples are given to illustrate various embodiments within the scope of the present invention. These are given by way of example only, and it is understood that the following examples are not comprehensive or exhaustive of the many types of embodiments of the present invention that can be prepared in accordance with the present invention.

### EXAMPLE 1

### Construction and Testing of Zn—NaSICON—MnO₂ Battery

A Zn—MnO₂ battery was constructed with NaSICON as the separator instead of a microporous separator. Battery grade manganese dioxide was purchased from Aldrich. Battery grade low gassing Zn metal powder was obtained from a commercial battery source. 50 wt. % aqueous sodium hydroxide was added such that stoichiometric amount of sodium hydroxide was present in the anode. Note that sodium hydroxide is not just an electrolyte but a participant in the anodic discharge reaction as follows:

Zn+2NaOH [symbol] Zn(OH)₂+2Na⁺+2e⁻

The opposite electrode or cathode contained about 20 wt. % graphite to improve the electrical conductivity. 25 wt. % NaOH was added to the MnO₂ cathode such that excess water was present in the catholyte. Note that water is a participant in the cathodic reaction as follows:

MnO₂+H₂O+Na⁺+e⁻ [symbol] MnOOH+NaOH

A stainless steel current collector was used with the zinc anode. Nickel current collector was used for the second electrode. A cylindrical two compartment Teflon cell was used to test the performance of the battery. The first compartment was filled with the zinc anode material and the second with the manganese oxide material. A NaSICON membrane was O-ring sealed between the two compartments. The active surface area of the membrane was 3.24 sq.cm.

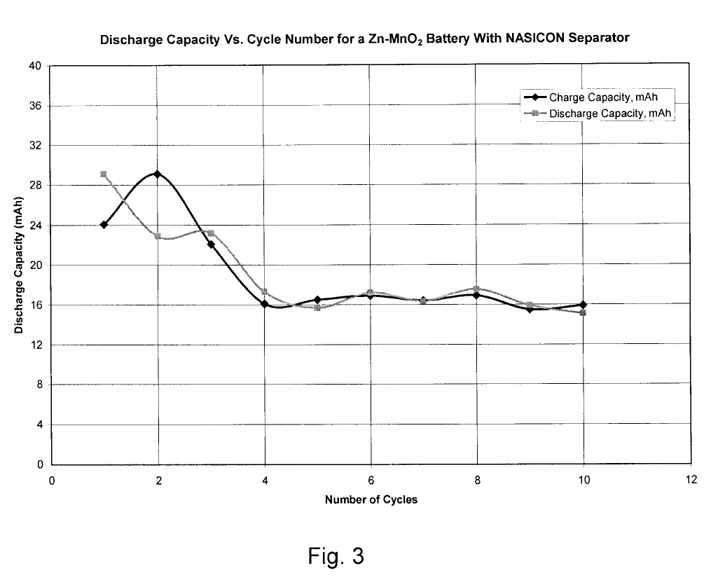

The cells were charged and discharged at a constant current of 2 mA between 1.0 V and 1.8 V volts. The discharge capacity versus cycle number is shown in FIG. 3. FIG. 3 shows that after 3 cycles the charge and discharge capacities stayed constant with cycle life. The data demonstrates the viability of a rechargeable Zn—MnO₂ battery incorporating NaSICON membrane.

While specific embodiments of the present invention have been illustrated and described, numerous modifications come to mind without significantly departing from the spirit of the invention, and the scope of protection is only limited by the scope of the accompanying claims.

1. A zinc anode battery comprising:
a first electrode comprising zinc;
a second electrode comprising an oxidizing material capable of electrochemical reduction by zinc;
an alkali-ion conductive, substantially non-porous separator disposed between the first and second electrode; and
an alkaline electrolyte contacting the first and second electrode.

2. The zinc anode battery according to claim 1, wherein the separator is a substantially non-porous, electronically insulating, ceramic separator material.

3. The zinc anode battery according to claim 1, wherein the separator is a substantially non-porous glass separator material.

4. The zinc anode battery according to claim 1, wherein the alkali ion conducting solid electrolyte is a specific alkali ion conductor.

5. The zinc anode battery according to claim 4, wherein the separator is a solid alkali metal ion conducting material, wherein the alkali metal is Na, K, or Li.

6. The zinc anode battery according to claim 4, wherein the separator comprises a material having the formula Me₁₊ₓZr₂SiₓP₃₋ₓO₁₂ where 0≦x≦3, where Me is Na, K, or Li.

7. The zinc anode battery according to claim 4, wherein the separator comprises a material having the formula Na₁₊ₓZr₂SiₓP₃₋ₓO₁₂ where 0≦x≦3.

8. The zinc anode battery according to claim 4, wherein the separator comprises a material having the formula Me₅RESi₄O₁₂ where Me is Na, K, or Li, where RE is Y, Nd, Dy, or Sm, or any mixture thereof.

9. The zinc anode battery according to claim 4, wherein the separator comprises a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where 6 is the measure of deviation from stoichiometry.

10. The zinc anode battery according to claim 4, wherein the separator comprises material with the formula Li₁₊ₓAlₓTi₂₋ₓ(PO₄)₃ or Li_{1.3}Al_{0.3}Ti_{1.7}(PO₄)₃.

11. The zinc anode battery according to claim 1, wherein the separator comprises a monolithic flat plate, a monolithic tube, a monolithic honeycomb, or supported structures of the foregoing.

12. The zinc anode battery according to claim 1, wherein the separator comprises a layered alkali ion conducting ceramic-polymer composite membrane, comprising alkali ion-selective polymers layered on alkali ion conducting ceramic solid electrolyte materials.

13. The zinc anode battery according to claim 1, wherein the second electrode comprises MnO₂.

14. The zinc anode battery according to claim 1, wherein the second electrode comprises AgO or Ag₂O.

15. The zinc anode battery according to claim 1, wherein the second electrode comprises NiOOH.

16. The zinc anode battery according to claim 1, wherein the second electrode comprises O₂.

17. The zinc anode battery according to claim 1, wherein the second electrode comprises material chosen from HgO CdO, Cu₂O or combinations thereof.

18. A method of charging a zinc anode battery having a first electrode comprising zinc, a second electrode comprising an oxidizing material capable of electrochemical reduction by zinc, an alkali hydroxide electrolyte, and a substantially non-porous alkali ion conducting separator, comprising the steps of:
applying an electric charging potential to the first and second electrodes to cause the following reaction to occur at the first electrode:
Zn(OH)₂+2Me⁺+2e⁻→Zn+2MeOH
and to cause the following reaction to occur at the second electrode:
Mₒₓ+2MeOH→MₒₓO+H₂O+2Me⁺+2e⁻
where Me is an alkali metal and Mₒₓ is the oxidizing material; and
conducting Me⁺ ions across the alkali ion conducting separator from the second electrode to the first electrode.

19. The method of charging a zinc anode battery according to claim 18, wherein the alkali ion conducting solid electrolyte is a specific alkali ion conductor.

20. The method of charging a zinc anode battery according to claim 18, wherein the separator is a solid alkali metal ion super ion conducting material, wherein the alkali metal is Na, K, or Li.

21. The method of charging a zinc anode battery according to claim 18, wherein the separator comprises a material having the formula Me₁₊ₓZr₂SiₓP₃₋ₓO₁₂ where 0≦x≦3, where Me is Na, K, or Li.

22. The method of charging a zinc anode battery according to claim 18, wherein the separator comprises a material having the formula Na₁₊ₓZr₂SiₓP₃₋ₓO₁₂ where 0≦x≦3.

23. The method of charging a zinc anode battery according to claim 18, wherein the separator comprises a material having the formula Me₅RESi₄O₁₂ where Me is Na, K, or Li, where RE is Y, Nd, Dy, or Sm, or any mixture thereof.

24. The method of charging a zinc anode battery according to claim 18, wherein the separator comprises a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where 6 is the measure of deviation from stoichiometry.

25. The method of charging a zinc anode battery according to claim 18, wherein the separator comprises a material of the formula Li₁₋ₓAlₓTi₂₋ₓ(PO₄)₃ or Li_{1.3}Al_{0.3}Ti_{1.7}(PO₄)₃.

26. The method of charging a zinc anode battery according to claim 18, wherein overcharging generates oxygen at the second electrode which is directed through a one way check valve to the first electrode which reduces the oxygen.

27. A method of discharging a zinc anode battery having a first electrode comprising zinc, a second electrode comprising an oxidizing material capable of electrochemical reduction by zinc, an alkali hydroxide electrolyte, and a substantially non-porous alkali ion conducting separator, comprising the steps of:
generating an electric potential between the first and second electrodes due in part to the following reaction occurring at the first electrode:
Zn+2MeOH→Zn(OH)₂+2Me⁺+2e⁻
and due in part to the following reaction occurring at the second electrode:
MₒₓO+H₂O+2Me⁺+2e⁻→Mₒₓ+2MeOH
where Me is an alkali metal and Mₒₓ is the oxidizing material; and
conducting Me⁺ ions across the alkali ion conducting separator from the first electrode to the second electrode.

28. The method of discharging a zinc anode battery according to claim 27, wherein the alkali ion conducting solid electrolyte is a specific alkali ion conductor.

29. The method of discharging a zinc anode battery according to claim 27, wherein the separator is a solid alkali metal ion super ion conducting material, wherein the alkali metal is Na, K, or Li.

30. The method of discharging a zinc anode battery according to claim 27, wherein the separator comprises a material having the formula Me₁₊ₓZr₂SiₓP₃₋ₓO₁₂ where 0≦x≦3, where Me is Na, K, or Li.

31. The method of discharging a zinc anode battery according to claim 27, wherein the separator comprises a material having the formula Na₁₊ₓZr₂SiₓP₃₋ₓO₁₂ where 0≦x≦3.

32. The method of discharging a zinc anode battery according to claim 27, wherein the separator comprises a material having the formula Me₅RESi₄O₁₂ where Me is Na, K, or Li, where RE is Y, Nd, Dy, or Sm, or any mixture thereof.

33. The method of discharging a zinc anode battery according to claim 27, wherein the separator comprises a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where 6 is the measure of deviation from stoichiometry.

34. The method of discharging a zinc anode battery according to claim 27, wherein the separator comprises a material having the formula Li₁₊ₓAlₓTi₂₋ₓ(PO₄)₃ or Li_{1.3}Al_{0.3}Ti_{1.7}(PO₄)₃.

35. The method of discharging a zinc anode battery according to claim 27, wherein overdischarging generates hydrogen at the second electrode which is directed through a one way check valve to the first electrode which reduces the hydrogen.

36. A method of inhibiting dendrite formation in a rechargeable zinc anode battery comprising:
obtaining a battery having a first electrode comprising zinc and a second electrode comprising an oxidizing material capable of electrochemical reduction by zinc; and
disposing an alkali-ion conductive, substantially non-porous separator disposed between the first and second electrodes.

37. A method of charging a zinc anode battery having a first electrode comprising zinc, a second electrode comprising an oxidizing material capable of electrochemical reduction by zinc, an alkali hydroxide electrolyte, and a substantially non-porous alkali ion conducting separator, comprising the steps of:
applying an electric charging potential to the first and second electrodes to cause the following reaction to occur at the first electrode:
Zn(OH)₂+2Me⁺+2e⁻→Zn+2MeOH
and to cause the following reaction to occur at the second electrode:
Mᵢ-Me→Mᵢ+Me⁺+e⁻
where Me is an alkali metal and Mᵢ is an oxidizing material that inserts Me⁺ ions on reduction and releases Me⁺ on oxidation; and
conducting Me⁺ ions across the alkali ion conducting separator from the second electrode to the first electrode.

38. The method of charging a zinc anode battery according to claim 37, wherein the alkali ion conducting solid electrolyte is a specific alkali ion conductor.

39. The method of charging a zinc anode battery according to claim 37, wherein the separator is a solid alkali metal ion super ion conducting material, wherein the alkali metal is Na, K, or Li.

40. The method of charging a zinc anode battery according to claim 37, wherein the separator comprises a material having the formula Me₁₊ₓZr₂SiₓP₃₋ₓO₁₂ where 0≦x≦3, where Me is Na, K, or Li.

41. The method of charging a zinc anode battery according to claim 37, wherein the separator comprises a material having the formula Na₁₊ₓZr₂SiₓP₃₋ₓO₁₂ where 0≦x≦3.

42. The method of charging a zinc anode battery according to claim 37, wherein the separator comprises a material having the formula Me₅RESi₄O₁₂ where Me is Na, K, or Li, where RE is Y, Nd, Dy, or Sm, or any mixture thereof.

43. The method of charging a zinc anode battery according to claim 37, wherein the separator comprises a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where 6 is the measure of deviation from stoichiometry.

44. The method of charging a zinc anode battery according to claim 37, wherein the separator comprises a material of the formula Li₁₊ₓAlₓTi₂₋ₓ(PO₄)₃ or Li_{1.3}Al_{0.3}Ti_{1.7}(PO₄)₃.

45. The method of charging a zinc anode battery according to claim 37, wherein overcharging generates oxygen at the second electrode which is directed through a one way check valve to the first electrode which reduces the oxygen.

46. A method of discharging a zinc anode battery having a first electrode comprising zinc, a second electrode comprising an oxidizing material capable of electrochemical reduction by zinc, an alkali hydroxide electrolyte, and a substantially non-porous alkali ion conducting separator, comprising the steps of:
generating an electric potential between the first and second electrodes due in part to the following reaction occurring at the first electrode:
Zn+2MeOH→Zn(OH)₂+2Me⁺+2e⁻
and due in part to the following reaction occurring at the second electrode:
Mᵢ+Me⁺+e⁻→Mᵢ-Me
where Me is an alkali metal and Mᵢ is an oxidizing material that inserts Me⁺ ions on reduction and releases Me⁺ on oxidation; and
conducting Me⁺ ions across the alkali ion conducting separator from the first electrode to the second electrode.

47. The method of discharging a zinc anode battery according to claim 46, wherein the alkali ion conducting solid electrolyte is a specific alkali ion conductor.

48. The method of discharging a zinc anode battery according to claim 46, wherein the separator is a solid alkali metal ion super ion conducting material, wherein the alkali metal is Na, K, or Li.

49. The method of discharging a zinc anode battery according to claim 46, wherein the separator comprises a material having the formula Me₁₊ₓZr₂SiₓP₃₋ₓO₁₂ where 0≦x≦3, where Me is Na, K, or Li.

50. The method of discharging a zinc anode battery according to claim 46, wherein the separator comprises a material having the formula Na₁₊ₓZr₂SiₓP₃₋ₓO₁₂ where 0≦x≦3.

51. The method of discharging a zinc anode battery according to claim 46, wherein the separator comprises a material having the formula Me₅RESi₄O₁₂ where Me is Na, K, or Li, where RE is Y, Nd, Dy, or Sm, or any mixture thereof.

52. The method of discharging a zinc anode battery according to claim 46, wherein the separator comprises a non-stoichiometric alkali-deficient material having the formula (Me₅RESi₄O₁₂)_{1-δ}(RE₂O₃.2SiO₂)_{δ}, where Me is Na, K, or Li, where RE is Nd, Dy, or Sm, or any mixture thereof and where 6 is the measure of deviation from stoichiometry.

53. The method of discharging a zinc anode battery according to claim 46, wherein the separator comprises a material having the formula Li₁₊ₓAlₓTi₂₋ₓ(PO₄)₃ or Li_{1.3}Al_{0.3}Ti_{1.7}(PO₄)₃.

54. The method of discharging a zinc anode battery according to claim 46, wherein overdischarging generates hydrogen at the second electrode which is directed through a one way check valve to the first electrode which reduces the hydrogen.
